(19) United States
(12) Patent Application Publication
(10) Pub. No.: US 2018/0357881 A1
(43) Pub. Date: Dec. 13, 2018

(54) DETECTION DEVICE AND DETECTION METHOD FOR AMOUNT OF REMAINING GAS OF SODA WATER MACHINE

(71) Applicant: TAISENBAO TECHNOLOGY HOLDINGS CO., LIMITED, Kowloon (HK)

(72) Inventors: CHIA-HSING LIEN, Taipei City (TW); JUNG-TAI CHIANG, Taipei City (TW)

(21) Appl. No.: 15/620,222

(22) Filed: Jun. 12, 2017

(51) Int. Cl. G08B 21/18; G01F 23/20; G01F 23/00; B01F 3/04; B01F 15/00

(52) U.S. Cl. CPC G08B 21/182; G01F 23/205; B01F 2215/0022; B01F 3/04801; B01F 15/00259; G01F 23/0069

(57) ABSTRACT

A detection device for an amount of remaining gas of a soda water machine includes a remaining gas amount sensor, a signal transmitter and a gas bottle sensing device. The remaining gas amount sensor detects the amount of remaining gas in a gas bottle of the soda water machine. When the amount of remaining gas in the gas bottle is lower than a predetermined value, the signal transmitter sends an alert signal to a user. The gas bottle sensing device detects whether the gas bottle is disposed on the soda water machine. The detection device and detection method using the above detection device for an amount of remaining gas of a soda water machine are capable of solving the issue that the gas bottle cannot be immediately replaced once the user discovers that the gas in a gas bottle connected to a soda water machine is insufficient.

### BACKGROUND OF THE INVENTION

### Field of the Invention

The present invention relates to a detection device and detection method for an amount of remaining gas of a soda water machine, and more particularly, to a detection device and detection method capable of detecting an amount of remaining gas in a gas bottle of a soda water machine.

### Description of the Prior Art

A conventional soda water machine may be connected to a gas bottle containing carbon dioxide, and manufacture soda water by pumping the carbon dioxide in the gas bottle into a bottle of bottled water. However, the conventional soda water machine usually cannot detect the amount of remaining gas in the gas bottle, and so a user remains unaware of a situation where the amount of remaining gas in the gas bottle is lower than a predetermined amount. Thus, only when the soda water machine becomes incapable of pumping sufficient gas into the bottled water, the user then only learns that the remaining gas in the gas bottle is insufficient. That is, the user cannot replace the gas bottle immediately and uninterrupted continual use of the soda water machine cannot be ensured.

### SUMMARY OF THE INVENTION

In view of the above issues, the present invention provides a detection device for an amount of remaining gas of a soda water machine to detect the amount of remaining gas in a gas bottle of the soda water machine. The soda water machine includes a seat, a gas delivering device, a gas bottle valve frame and a gas bottle valve assembly. The gas delivering device and the gas bottle valve frame are disposed on the seat. The gas bottle valve assembly is disposed on the gas bottle valve frame. The detection device includes a remaining gas amount sensor and a signal transmitter. The remaining gas amount sensor is disposed on the seat of the soda water machine, and detects the amount of remaining gas in the gas bottle. The signal transmitter, coupled to the remaining gas amount sensor, sends an alert signal to a user when the remaining gas amount sensor detects that the amount of remaining gas in the gas bottle is lower than a predetermined value.

The above detection device further includes a gas bottle sensing device coupled to the remaining gas amount sensor. The gas bottle sensing device detects whether the gas bottle is disposed on the soda water machine. When the remaining gas amount sensor is a weight sensor, the remaining gas amount sensor resets a detected predetermined weight value to zero once the gas bottle sensing device detects that the gas bottle is not disposed on the soda water machine.

In the above detection device, the gas bottle sensing device may be an infrared sensor or an optical interrupter.

The above detection device further includes a display screen coupled to the remaining gas amount sensor. The display screen displays the amount of remaining gas in the gas bottle that the remaining gas amount sensor detects in real-time.

The above detection device further includes a recording device coupled to the remaining gas amount sensor. The recording device records the amount of remaining gas in the gas bottle that the remaining gas amount sensor detects.

In the above detection device, the signal transmitter may be an indicator light, a sound emitting device or a wireless communication device.

In the above detection device, the signal transmitter is a wireless communication device, and sends the alert signal to an end user.

In the above detection device, the remaining gas amount sensor may be a weight sensor, a gas flowmeter or a pressure gauge.

To achieve the above and other objects, the present invention provides a detection method for an amount of remaining gas of a soda water machine to detect the amount of remaining gas in a gas bottle of the soda water machine. The soda water machine includes a seat, a gas delivering device, a gas bottle valve frame and a gas bottle valve assembly. The gas delivering device and the gas bottle valve frame are disposed on the seat. The gas bottle valve assembly is disposed on the gas bottle valve frame. The detection method includes: a) providing a detection device for the amount of remaining gas of the soda water machine, the detection device including a remaining gas amount sensor, a signal transmitter and a gas bottle sensing device, the remaining gas amount sensor being a weight sensor disposed on the seat of the soda water machine and sensing the amount of remaining gas in the gas bottle, the signal transmitter coupled to the remaining gas amount sensor, the gas bottle sensing device coupled to the remaining gas amount sensor and sensing whether the gas bottle is disposed on the soda water machine; b) the gas bottle sensing device sensing whether the gas bottle is disposed on the soda water machine; the remaining gas amount sensor resetting a detected predetermined weight value to zero when the gas bottle sensing device detects that the gas bottle is not disposed on the soda water machine; and the remaining gas amount sensor detecting the amount of remaining gas in the gas bottle when the bottle sensing device detects that the gas bottle is disposed on the soda water machine; and c) when the remaining gas amount sensor detects that the amount of remaining gas in the gas bottle is lower than a predetermined value, the signal transmitter sending an alert signal to a user.

Thus, the above detection device and detection method for an amount of remaining gas of a soda water machine are capable of solving the issue that a gas bottle cannot be immediately replaced once a user discovers that gas in a gas bottle of the soda water machine is insufficient.

### BRIEF DESCRIPTION OF THE DRAWINGS

FIG. 1 is an exploded schematic diagram of a detection device according to a first embodiment of the present invention;

FIG. 2 is an appearance schematic diagram a detection device according to the first embodiment of the present invention;

FIG. 3 is an exploded schematic diagram of a detection device according to a second embodiment of the present invention;

FIG. 4 is an exploded schematic diagram of a detection device according to a third embodiment of the present invention;

FIG. 5 is an exploded schematic diagram of a detection device according to a fourth embodiment of the present invention;

FIG. 6 is a flowchart of a detection method of a detection device according to the fourth embodiment of the present invention; and

FIG. 7 is an exploded schematic diagram of a detection device according to a fifth embodiment of the present invention.

### DETAILED DESCRIPTION OF THE EMBODIMENTS

To thoroughly understand objects, features and effects of the present invention, embodiments of the present invention are described in detail below with reference to the accompanying drawings.

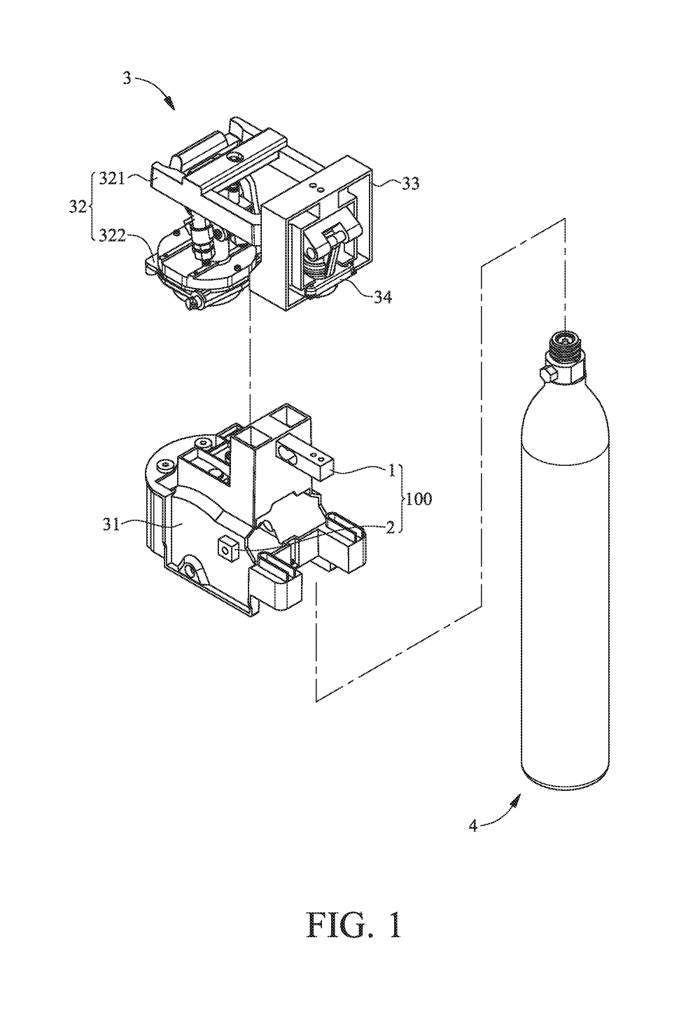

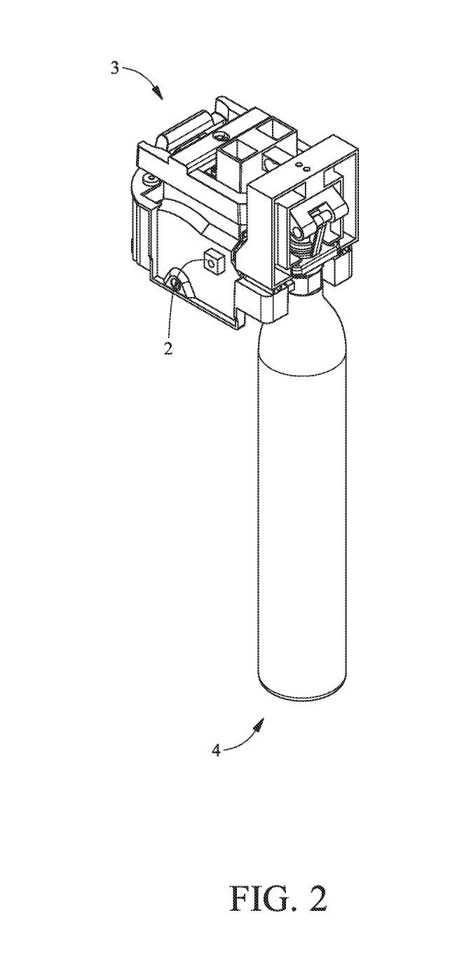

FIG. 1 and FIG. 2 show a detection device 100 for an amount of remaining gas of a soda water machine according to a first embodiment of the present invention. The detection device 10 is for detecting an amount of remaining gas in a gas bottle 4 of a soda water machine 3, and includes a seat 31, a gas delivering device 32, a gas bottle valve frame 33 and a gas bottle valve assembly 34. The gas delivering device 32 and the gas bottle valve 33 are disposed on the seat 31. The gas bottle valve assembly 34 is disposed on the gas bottle valve frame 33. A user may connect a bottle of bottled water (not shown) to the gas delivering device 32, and pump gas in the gas bottle 4 into the bottled water through the gas delivering device 32. The detection device 100 includes a remaining gas amount sensor 1 and a signal transmitter 2. The remaining gas amount sensor 1 is disposed on the seat 31 of the soda water machine 3 to detect the amount of remaining gas in the gas bottle 4. In the first embodiment of the present invention, the remaining gas amount sensor 1 is a weight sensor, and detects the amount of remaining gas in the gas bottle 4 through detecting the weight of the gas in the gas bottle 4. The remaining gas amount sensor 1 may also be replaced by a gas flowmeter or a pressure gauge, and is not limited to the first embodiment of the present invention. The signal transmitter 2 is coupled to the remaining gas amount sensor 1. When the remaining gas amount sensor 1 detects that the amount of remaining gas in the gas bottle 4 is lower than a predetermined value, the signal transmitter 2 sends an alert signal to the user. In the first embodiment of the present invention, the signal transmitter 2 is an alert light. When the alert light sends the alert signal by issuing a flash light to the user, it means that the amount of remaining gas in the gas bottle 4 is lower than the predetermined value. Alternatively, the signal transmitter 2 may be replaced by a sound emitting device, e.g., a beeper, and is not limited by the first embodiment of the present invention. With the remaining gas amount sensor 1 and the signal transmitter 2, the detection device 100 reminds the user that the amount of remaining gas in the gas bottle 4 is lower than a predetermined value, thereby solving the issue that a gas bottle cannot be immediately replaced once a user discovers that gas in a gas bottle of the soda water machine is insufficient.

In the first embodiment, the remaining gas amount sensor 1 detects the weight of the gas in the gas bottle 4 by deducting the weight of the gas bottle 4 and the weight of components of the soda water machine 3 that the remaining gas amount sensor 1 detects from the total weight that the remaining gas amount sensor 1 detects. In the first embodiment of the present invention, the weight of the gas bottle 4 fully filled with gas is 1200 g, and the weight of the gas bottle 4 alone is 780 g. That is, when the gas bottle 4 is fully filled with gas, the weight of the gas is 420 g (which may be pumped for approximately 40 times). The weight of the components of the soda water machine 3 that the remaining gas amount sensor 1 detects is 120 g, and the weight of the gas that the soda water machine 3 draws from the gas bottle 4 is approximately 10 g to 13 g. The user may set the predetermined value such that the signal transmitter 2 sends the alert signal to the user when the remaining gas amount sensor 1 detects that the weight of the gas in the gas bottle 4 is 25 g (which may be pumped for approximately twice).

In the first embodiment of the present invention, the gas delivering device 32 includes a pumping lever 321 and a gas valve assembly 322. The bottled water is connected to the gas valve assembly 322. The user pumps the gas in the gas bottle 4 into the bottle of bottled water by pressing the pumping lever 321. In another embodiment, the gas delivering device 32 may also be designed as an automatic gas delivering device instead of a device that requires manual pumping of the user.

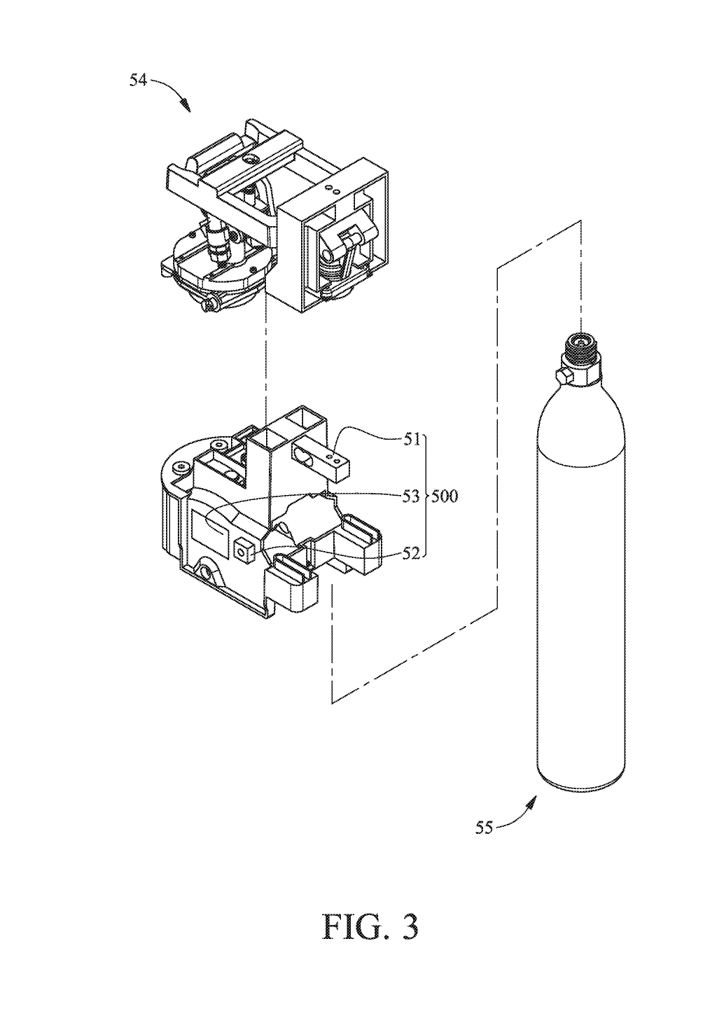

FIG. 3 shows a detection device 500 for an amount of remaining gas of a soda water machine according to a second embodiment of the present invention. The detection device 500 includes a remaining gas amount sensor 51 and a signal transmitter 52. Functional and structural details of the detection device 500 are substantially identical to those of the detection device 100 in FIG. 1, with however the detection device 500 further including a display screen 53. The display screen 53 is coupled to the remaining gas amount sensor 51, and further displays the amount of remaining gas in a gas bottle 55 of a soda water machine 54 that the remaining gas amount sensor 51 detects in real-time. Thus, the user is allowed to more specifically learn the amount of remaining gas in the gas bottle 55 to further determine when to replace or refill the gas in the gas bottle 55.

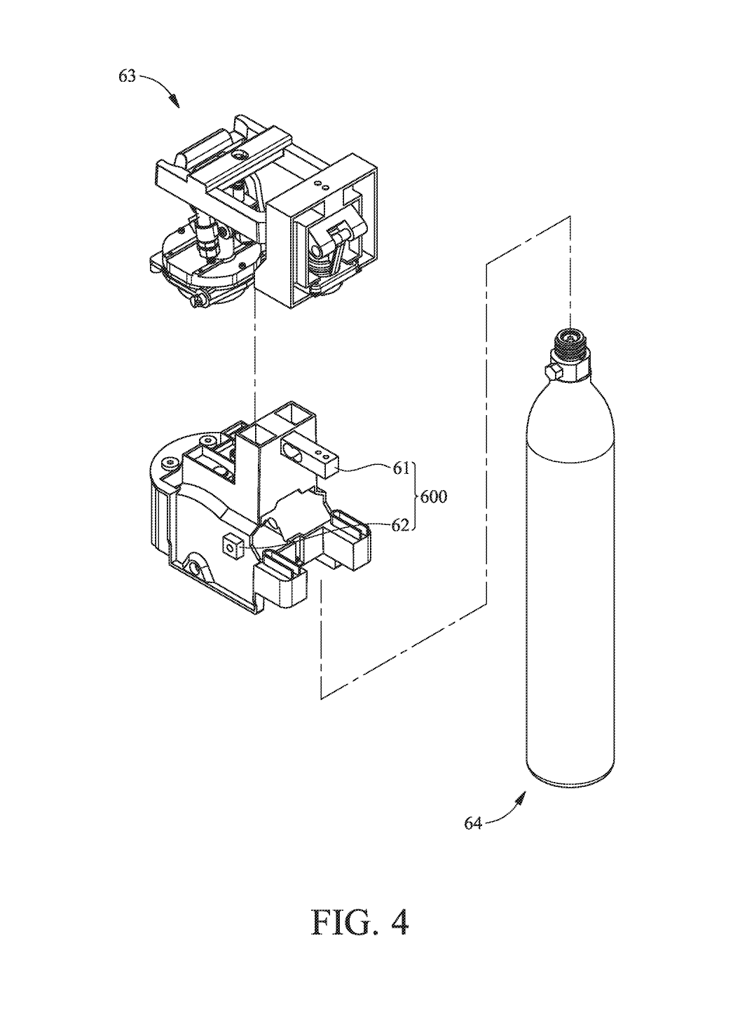

FIG. 4 shows a detection device 600 for an amount of remaining gas of a soda water machine according to a third embodiment of the present invention. The detection device 600 includes a remaining gas amount sensor 61 and a signal transmitter 62. Functional and structural details of the detection device 600 are substantially identical to those of the detection device 100 in FIG. 1, with however the detection device 600 further including a recording device (not shown) coupled to the remaining gas amount sensor 61. When the remaining gas amount sensor 61 detects the amount of remaining gas in a gas bottle 64 of a soda water machine 63, the recording device records the current amount of remaining gas in the gas bottle 64 that the remaining gas amount sensor 61 detects. The change in the amount of remaining gas in the gas bottle 4 and the consumption speed of the gas in the gas bottle 64 recorded by the recording device may be used as reference data when the user applies the soda water machine.

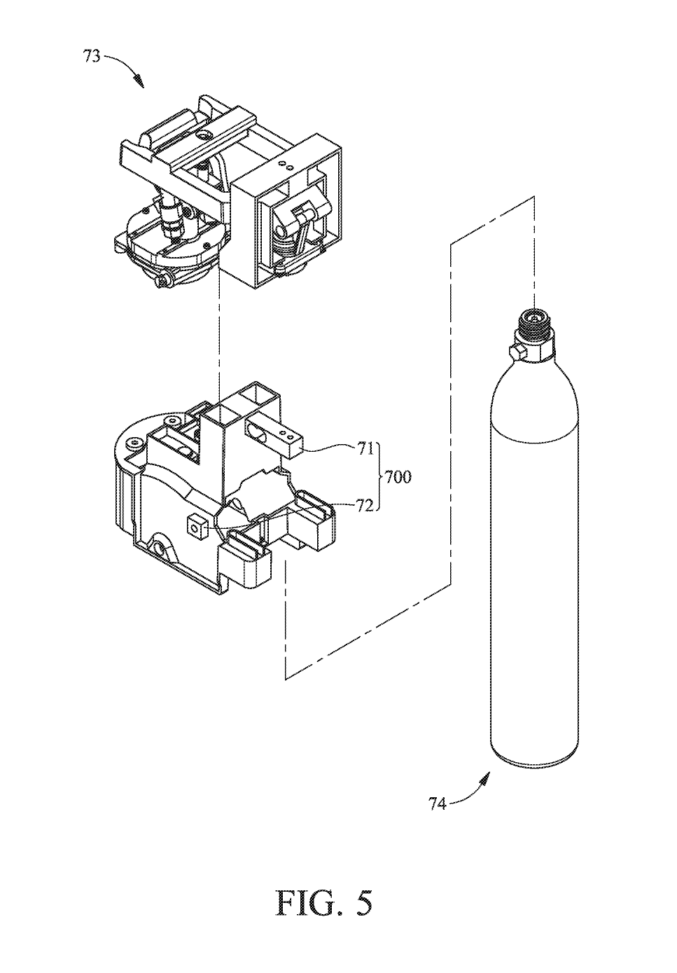

FIG. 5 shows a detection device 700 for an amount of remaining gas of a soda water machine according to a fourth embodiment of the present invention. The detection device 700 includes a remaining gas amount sensor 71 and a signal transmitter 72. Functional and structural details of the detection device 700 are substantially identical to those of the detection device 100 in FIG. 1, with however the detection device 700 further including a gas bottle sensing device (not shown). In this embodiment, the gas bottle sensing device is an optical interrupter, or may be an infrared sensor or other devices capable of sensing an object. The gas bottle sensing device is coupled to the remaining gas amount sensor 71, and detects whether a gas bottle 74 is disposed on a soda water machine 73.

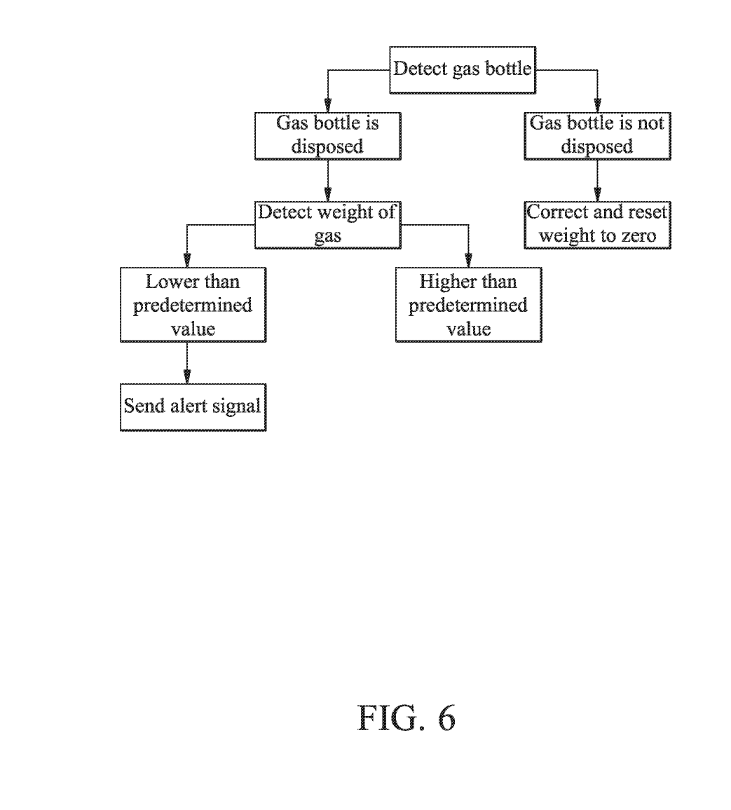

Referring to FIG. 6, a user may perform a detection method for an amount of remaining gas in a soda water machine through the detection device 700. When the gas bottle sensing device detects that the gas bottle 74 is not disposed on the soda water machine 73, the remaining gas amount sensor 71 corrects and resets a detected weight value to zero (the weight of components of the soda water machine 73 detected by the remaining gas amount sensor 71); when the gas bottle sensing device detects that the gas bottle 74 is disposed on the soda water machine 73, the remaining gas amount sensor 71 detects whether the amount of remaining gas in the gas bottle 74 is lower or higher than a predetermined value. When the remaining gas amount sensor 71 detects that the amount of remaining gas of the gas bottle is lower than the predetermined threshold, the signal transmitter 72 sends an alert signal to the user. Thus, the gas bottle sensing device is capable of preventing erroneously detecting weight that is lower than the predetermined value when the soda water machine 73 is not connected to the gas bottle, so as to prevent the signal transmitter 72 from sending an incorrect alert signal to the user.

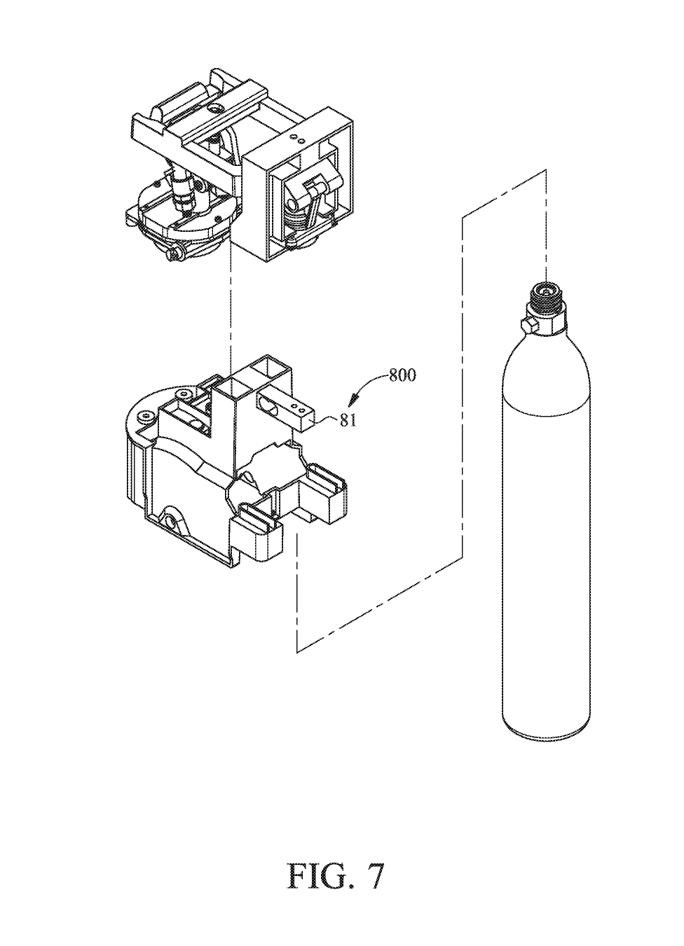

FIG. 7 shows a detection device 800 for an amount of remaining gas of a soda water machine according to a fifth embodiment of the present invention. The detection device 800 includes a remaining gas amount sensor 81 and a signal transmitter. Functional and structural details of the detection device 800 are substantially identical to those of the detection device 100 in FIG. 1, with however the signal transmitter being a wireless communication device. The signal transmitter sends the alert signal to an end user. In this embodiment, the signal transmitter sends the alert signal to an application in a smart phone of the user, or the signal transmitter may also be designed to send the alert signal to a phone of the user through a short message service (SMS). Further, the signal transmitter may also send the alert signal through an email or a message of social software to a cell phone, computer or other electronic devices of the user, and is not limited to the embodiment.

As described, the detection device and detection method for an amount of remaining gas of a soda water machine of the present invention, with the remaining gas amount sensor and the signal transmitter, are capable of reminding the user that the amount of remaining gas in the gas bottle is lower than a predetermined value. Thus, the detection device solves the issue that a gas bottle cannot be immediately replaced once the user discovers that the gas in the gas bottle is insufficient.

Meanwhile, the gas bottle sensing device is capable of preventing erroneously detecting a weight lower than the predetermined value when the soda water machine is not connected to the gas bottle, so as to prevent the signal transmitter from sending an incorrect alert signal to the user.

The display screen further displays the amount of remaining gas in the gas bottle that the remaining gas amount sensor detects in real-time. Thus, the user is allowed to more accurately learn the amount of remaining gas in the gas bottle to further determine when to replace or refill the gas in the gas bottle 55.

The recording device records the current amount of remaining gas that the remaining gas amount sensor detects. The change in the amount of remaining gas in the gas bottle and the consumption speed of the gas in the gas bottle recorded by the recording device may be used as reference data when the user applies the soda water machine.

The signal transmitter may be a wireless communication device that sends the alert signal to the end user to allow the user to stay aware of whether the amount of remaining gas in the gas bottle is too low at all times in all circumstances.

While the invention has been described in terms of what is presently considered to be the most practical and preferred embodiments, it is to be understood that the invention is only illustrative and needs not to be limited to the above embodiments. It should be noted that, equivalent variations and replacements made to the embodiments are to be encompassed within the scope of the present invention. Therefore, the scope of the present invention is to be accorded with the appended claims.

What is claimed is:

1. A detection device for an amount of remaining gas of a soda water machine, for detecting an amount of remaining gas of a soda water machine, the soda water comprising a seat, a gas delivering device, a gas bottle valve frame and a gas bottle valve assembly, the gas delivering device and the gas bottle valve frame disposed on the seat, the gas bottle valve assembly disposed on the gas bottle valve frame, the detection device comprising:
a remaining gas amount sensor, disposed on the seat of the soda water machine, for detecting the amount of remaining gas in the gas bottle; and
a signal transmitter, coupled to the remaining gas amount sensor;
wherein, when the remaining gas amount sensor detects that the amount of remaining gas in the gas bottle is lower than a predetermined value, the signal transmitter sends an alert signal to a user.

2. The detection device of claim 1, further comprising:
a gas bottle sensing device, coupled to the remaining gas amount sensor, for detecting whether the gas bottle is disposed on the soda water machine;
wherein, the remaining gas amount sensor is a weight sensor, and resets a detected predetermined weight value to zero when the gas bottle sensing device detects that the gas bottle is not disposed on the soda water machine.

3. The detection device of claim 2, wherein the gas bottle sensing device is an infrared sensor or an optical interrupter.

4. The detection device of claim 1, further comprising:
a display screen, coupled to the remaining gas amount sensor, for displaying the amount of remaining gas in the gas bottle that the remaining gas amount sensor detects in real-time.

5. The detection device of claim 1, further comprising:
a recording device, coupled to the remaining gas amount sensor, for recoding the amount of remaining gas in the gas bottle that the remaining gas amount sensor detects.

6. The detection device of claim 5, wherein the signal transmitter is an indicator light, a sound emitting device or a wireless communication device.

7. The detection device of claim 6, wherein the signal transmitter is a wireless communication device and sends the alert signal to a user end.

8. The detection device of claim 1, wherein the remaining gas amount sensor is a weight sensor, a gas flowmeter or a pressure gauge.

9. A detection method for an amount of remaining gas in a soda water machine, for detecting an amount of remaining gas in a gas bottle of a soda water machine, the soda water machine comprising a seat, a gas delivering device, a gas bottle valve frame and a gas bottle valve assembly, the gas delivering device and the gas bottle valve frame disposed on the seat, the gas bottle valve assembly disposed on the gas bottle valve frame, the detection method comprising:
a) providing a detection device for the amount of remaining gas of the soda water machine, the detection device comprising:
a remaining gas amount sensor, being a weight sensor, disposed on the seat of the soda water machine, for detecting the amount of remaining gas in the gas bottle;
a signal transmitter, coupled to the remaining gas amount sensor; and
a gas bottle sensing device, coupled to the remaining gas amount sensor, for detecting whether the gas bottle is disposed on the soda water machine;
b) the gas bottle sensing device detecting whether the gas bottle is disposed on the soda water machine; when the gas bottle sensing device detects that the gas bottle is not disposed on the soda water machine, the remaining gas amount sensor resetting a detected predetermined weight value to zero; when the gas bottle sensing device detects that the gas bottle is disposed on the soda water machine, the remaining gas amount sensor detecting the amount of remaining gas in the gas bottle; and
c) when the amount of remaining gas in the gas bottle that the remaining gas amount sensor detects is lower than a predetermined value, the signal transmitter sending an alert signal to a user.
